(19) United States
(12) Patent Application Publication
(10) Pub. No.: US 2015/0197673 A1
(43) Pub. Date: Jul. 16, 2015

(54) Liquid Epoxy Resin Composition and Adhesive Using the Composition

(71) Applicant: SOMAR CORPORATION, Tokyo (JP)

(72) Inventors: Masami IIZUKA, Tokyo (JP); Tetsushi TAKATA, Tokyo (JP)

(73) Assignee: SOMAR CORPORATION, Tokyo (JP)

(21) Appl. No.: 14/584,120

(22) Filed: Dec. 29, 2014

(30) Foreign Application Priority Data
Jan. 16, 2014 (JP) 2014-006296

(51) Int. Cl. C09J 163/00

(52) U.S. Cl. CPC C09J 163/00

(57) ABSTRACT

Embodiments of the present invention provide an adhesive requiring a low modulus of elasticity and a liquid epoxy resin composition that is used for the adhesive thereof. The liquid epoxy resin composition not only exhibits flexibility or a low modulus of elasticity to prevent magnet cracking in the manufacturing of a rotor, using a ferrite magnet in particular, but also does not undergo a decrease in weight while exhibits minimal dimensional change. This is true even if the liquid epoxy resin is immersed in an automatic transmission fluid, for a long period of time, in an environment which is used as a rotor. The liquid epoxy resin composition according to the embodiments of the present invention includes a bisphenol A type epoxy resin, an epoxy resin containing a polyoxyalkylene structure, and a curing agent as essential components, used for the adhesive.

This application claims priority under 35 U.S.C. § 119 to Japanese Patent Application Serial No. 2014-006296, filed Jan. 16, 2014, which is incorporated by reference herein in its entirety.

### TECHNICAL FIELD

The present invention relates to an adhesive requiring a low modulus of elasticity and to a liquid epoxy resin composition that is used for the adhesive thereof

### BACKGROUND OF THE DISCLOSURE

Conventionally, epoxy resin compositions are widely used as adhesives that are used for motors and the like. In particular, they are used to bond a magnet to a motor body. However, with conventional adhesives that use epoxy resin compositions, depending on the type of magnet, a problem of cracks occurs in the magnet when the adhesive is cured or when used in an environment with temperature fluctuations after curing. Thus a demand has arisen for an adhesive with flexibility and a lower modulus of elasticity.

In particular, when a bisphenol A type epoxy resin, which is universally used from an economical point of view, is used in an adhesive to bond magnets, a problem occurred. Namely, cracks are not generated with neodymium magnets, but cracks are generated with ferrite magnets. Therefore, adhesives that blend resins, additives, and the like to impart flexibility with bisphenol A-type epoxy resin are examined. And, an epoxy resin composition containing a compound having an epoxy group, a cross-linked acrylic rubber, a curing agent for the compound containing an epoxy group, and a curing accelerator has been proposed as an adhesive for bonding magnets that adhesive property does not decrease and is capable of preventing a magnet from cracking and falling off (Patent Document 1: Japanese Unexamined Patent Application Publication No. H08-283687).

On the other hand, regarding the method for bonding the magnet, and more specifically the bonding of a magnet in the manufacture of an Interior Permanent Magnet (hereinafter, “IPM”) rotor, when a ferrite magnet is used in particular, the epoxy resin composition used as an adhesive must not only be flexible in order to prevent cracks in the magnet, or in other words, must have a low modulus of elasticity, it must also have properties that include no weight reduction and minimal dimensional changes even if immersed for a long period of time in automatic transmission fluid in an environment with use as a rotor (hereinafter, “oil resistance”). However, sufficient oil resistance could not be provided with adhesives obtained by blending resins, additives, and the like for imparting flexibility with a bisphenol A type epoxy resin.

### SUMMARY OF THE INVENTION

The inventors of the present invention conducted earnest research in order to resolve the above-described problems. And as a result, the inventors discovered that by using cured products of adhesives obtained from an epoxy resin composition which comprises a bisphenol A type epoxy resin, an epoxy resin containing a polyoxyalkylene structure, and a curing agent as essential components, cracking of magnets can be prevented, and resistance with respect to automatic transmission fluid is shown. The former effect is shown when an adhesive is cured or cured products are used in an environment with temperature changes, particularly when a ferrite magnet is used. The present inventors arrived at the present invention based on this knowledge.

Embodiments of the present invention provides:

(1) A liquid epoxy resin composition containing a bisphenol A type epoxy resin, an epoxy resin containing a polyoxyalkylene structure, and a curing agent as essential components.

(2) An adhesive containing the liquid epoxy resin composition according to (1).

The present invention relates to an epoxy resin composition having a bisphenol A type epoxy resin, an epoxy resin containing a polyoxyalkylene structure, and a curing agent as essential components. And, a cured product of an adhesive obtained from this composition excels in flexibility, and thus, when the adhesive is cured, or when the cured product is used in an environment with temperature changes after curing, cracking of the magnet can be prevented particularly when a ferrite magnet is used. Moreover, after having immersed an adhesive in automatic transmission fluid for a long period of time, the weight of the adhesive does not decrease, and dimensional changes thereof are minimal, and thus the adhesive exhibits excellent oil resistance. Accordingly, the adhesive according to the embodiments of the present invention is extremely useful as an adhesive for bonding a magnet to an adherend, and particularly as an adhesive for bonding a ferrite magnet used in an IPM rotor.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 is a diagram showing a relationship between the storage modulus of elasticity and temperature for an example and comparative examples.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment(s) of the disclosure. It should be understood that various changes may be made in the function and arrangement of elements without departing from the spirit and scope of the invention as set forth in the appended claims.

This disclosure relates in general to an adhesive requiring a low modulus of elasticity and to a liquid epoxy resin composition that is used for the adhesive thereof. More specifically, it is related to a new liquid epoxy resin composition having a bisphenol A type epoxy resin, an epoxy resin containing a polyoxyalkylene structure, and a curing agent as essential components.

The bisphenol A type epoxy resin is synthesized through a reaction between bisphenol A and epichlorohydrin, and the epoxy equivalent weight and molecular weight of the bisphenol A type epoxy resin thereby obtained can be appropriately selected in accordance with the desired viscosity. In the present embodiment, a single type of bisphenol A type epoxy resin may be used. In other embodiments, two or more types bisphenol A type epoxy resin, having different epoxy equivalent weights and molecular weights, may be used in combination.

The epoxy resin containing a polyoxyalkylene structure is not particularly limited as long as it contains a polyoxyalkylene structure in the molecule, and any epoxy resin thereof may be appropriately selected. As explained above, a single epoxy resin or two or more types thereof may be used in combination.

In particular, the blending amount of the bisphenol A type epoxy resin is preferably such that the upper limit amount is 35 weight % and the lower limit amount is 10 weight % with respect to the total amount of the epoxy resin composition. When the blending amount of the bisphenol A type epoxy resin is within this range, cracking of the adherend caused by a volume change of the resin cured product and a decrease in resistance with respect to an automatic transmission fluid do not easily occur.

On the other hand, the blending amount of the epoxy resin containing a polyoxyalkylene structure is preferably such that the upper limit amount is 35 weight % and the lower limit amount is 10 weight % with respect to the total amount of the epoxy resin composition. When the blending amount of the epoxy resin containing a polyoxyalkylene structure is within this range, the modulus of elasticity is decreased, and excellent flexibility can be obtained.

Specific examples of the curing agents may include linear aliphatic amine, alicyclic amine, aromatic amine, secondary and tertiary amine, aliphatic acid anhydride, aromatic acid anhydride, alicyclic acid anhydride, imidazole derivatives, urea derivatives, polymercaptan compounds, polyisocyanate compounds, dicyandiamide and derivatives thereof, boron trifluoride amine complex, hydrazide adipate and other organic acid hydrazides, and the like. In the present invention, these curing agents may be used as a single or as a combination of two or more types.

If desired, the epoxy resin composition according to the embodiments of the present invention may also be appropriately blended with inorganic particles. Specific examples of inorganic particles may include crystalline silica, fused silica, aluminum oxide, aluminum hydroxide, calcium carbonate, magnesium carbonate, magnesium oxide, mica, talc, kaolin, clay, dolomite, titanium oxide, iron oxide, carbon black, glass fiber, and the like. Similarly, the inorganic particles may be used as a single or as a combination of two or more types. Moreover, the average particle diameter of the inorganic particles is not particularly limited, and may be appropriately selected with inorganic particles of any particle diameters.

Conventional additives that are customarily used can be added in the epoxy resin composition of the present invention. Specific examples may include diluents, coloring agents, dyes, antifoaming agents, surfactants, silane coupling agents, viscosity modifiers, and the like.

In the context of the present invention, the term “modulus of elasticity” is to be understood as the tensile storage modulus of elasticity. More specifically, it is the tensile storage modulus of elasticity measured using a rotational rheometer (trade name “EXSTAR 6000/DMS 6100” from SII Nano Technology Inc.).

The present invention will next be described more specifically using examples, but the present invention is not limited to these examples.

### Producing Epoxy Resin Compositions

An example and comparative examples of epoxy resin compositions were produced by homogeneously mixing epoxy resin and curing agents using a planetary mixer. The blending ratios of the constituent components are shown in Table 1.

### Constituent Components of the Epoxy Resin Compositions

Epoxy resin (1): bisphenol A type liquid epoxy resin (trade name “jER 828” from Mitsubishi Chemical Corporation, epoxy equivalent weight of 184 to 194 g/eq)

Epoxy resin (2): epoxy resin having a polyoxyalkylene structure (trade name “Adeka Resin EP-4005” from ADEKA Corporation, epoxy equivalent weight of 475 to 575 g/eq)

Epoxy resin (3): dimer acid glycidyl ester type epoxy resin (trade name “jER 871” from Mitsubishi Chemical Corporation, epoxy equivalent weight of 390 to 470 g/eq)

Curing agent: modified polyamide (trade name “Ancamide-910” from Air Products & Chemicals, Inc.)

### Epoxy Resin Composition Evaluations

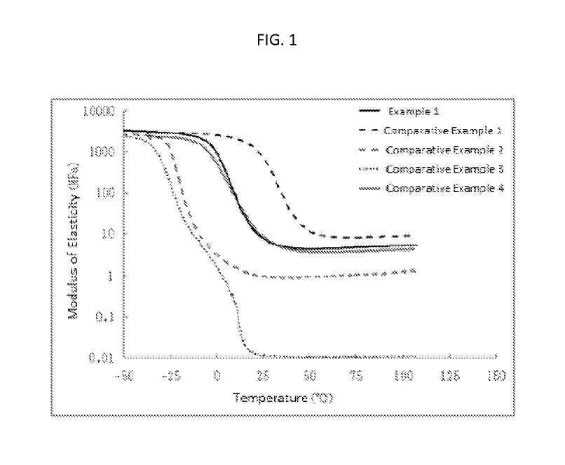

The moduli of elasticity of the obtained epoxy resin compositions were measured, and the appearances (magnet cracks) were observed. In addition, the oil resistances thereof were also evaluated by measuring the weight change rate, the dimensional change rate, and the tensile strength before and after immersion in automatic transmission fluid. The measurement methods are described below, and the evaluation results are shown in Table 1 and FIG. 1.

### Modulus of Elasticity Measurement

The tensile storage moduli of elasticity of cured products obtained by heating for 40 minutes at 120° C. were measured in a temperature range of −30 to 200° C. with a rate of temperature increase of 2° C./minute at a frequency of 10 Hz using a dynamic viscoelasticity measuring device (trade name EXSTAR 6000/DMS 6100 from SII Nano Technology Inc.).

When the epoxy resin compositions were used as the adhesive, generally as the figures that were obtained became lower, it became more difficult for cracking of the adherend to occur.

### Appearance (Magnet Cracking)

Using a metal plate as an adherend, magnets were bonded to the adherends using the obtained epoxy resin compositions as the adhesives. Heating was then implemented for 40 minutes at 120° C., after which the appearances of the magnets were observed, and the presence of initial cracking was confirmed. Temperature cycle tests were then alternately and repeatedly performed 100 times in temperature environments of −50° C. and 160° C. on those samples in which cracking did not occur after curing, with the samples being left for a certain period of time in the respective temperature environments, after which the presence of cracks was once again confirmed.

### Oil Resistance Evaluation (Weight Change Rate)

Oil resistance tests were conducted by inserting cured products obtained by heating for 40 minutes at 120° C. into a pressure-resistant airtight container having a volume of 1.7 L together with 1 kg of automatic transmission fluid (trade name “ATF DEXRON VI” from Petro-Canada), and leaving the cured products immersed for 500 hours at a temperature of 170° C. The changes in weight of the cured products before and after the tests were calculated.

When the epoxy resin compositions were used as the adhesives, good oil resistance values were generally obtained when the weight change rate was between 0 to 15%.

### Oil Resistance Evaluation (Dimensional Change Rate)

Cured products obtained by heating for 40 minutes at 120° C. were shaped in a size of 115 mm long by 25 mm wide, and oil resistance tests were conducted in the same manner as with the weight change rate, after which the longitudinal dimensions of the cured products before and after the test were measured, and the dimensional change was calculated.

When the epoxy resin compositions were used as the adhesives, good oil resistance values were generally obtained when the dimensional change rage was between −5 to 5%.

### Oil Resistance Evaluation (Tensile Strength)

Cured products obtained by heating for 40 minutes at 120° C. were measured in accordance with JIS K 6911. The cured products were shaped into JIS No. 2 dumbbell pieces, oil resistance tests were conducted in the same manner as with the weight change rate, and a tensile tester (trade name “Tensilon Universal Testing Instrument” from A&D Co., Ltd.) was used to measure the tensile strength of cured products before and after testing at a temperature of 25° C. and a tension speed of 50 mm/minute.

As shown in FIG. 1, it is clear that with Comparative Example 1, which is a blend of only the bisphenol A type epoxy resin, the modulus of elasticity is notably high in a temperature range from low temperatures to near 25° C. On the other hand, it is clear that with Comparative Examples 2 and 3, which are blends of flexibility imparting resins ordinarily known as flexible resins in place of a bisphenol A type epoxy resin, the modulus of elasticity decreases notably in a broad temperature range from temperatures near −25° C. to the high temperature range.

TABLE 1
Examples of blending ratios of the constituent components

| | | | Comparative | Comparative | Comparative | Comparative |
|---|---|---|---|---|---|---|
| | | Example 1 | Example 1 | Example 2 | Example 3 | Example 4 |
| Epoxy Resin (1) | | 50 | 100 | | | 50 |
| Epoxy Resin (2) | | 50 | | 100 | | |
| Epoxy Resin (3) | | | | | 100 | 50 |
| Curing Agent | | 80 | 120 | 45 | 50 | 85 |
| Appearance | Initial | No cracks | No cracks | No cracks | No cracks | No cracks |
| (Magnet | After Temperature Cycle Test | No cracks | Cracking | No cracks | No cracks | No cracks |
| Cracks) | | | | | | |
| Oil | Weight Change Rate (%) | 12.3 | 9.1 | 19.9 | −45.1 | −3.2 |
| Resistance | Dimensional Change Rate (%) | 2.6 | 2.6 | 8.7 | −20.0 | 0.0 |
| Evaluation | Tensile Strength Before Test (MPa) | 2.1 | 10 | 0.6 | 0.5 | 2.6 |
| | Tensile Strength After Test (MPa) | 2.3 | 12 | 0.5 | 0.4 | 5.0 |

Moreover, as indicated in Table 1, it is clear that the resin composition of Example 1 exhibits good results in the oil resistance evaluations, and magnet cracks were not generated. Comparative Example 1 is a blend of only a bisphenol A type epoxy resin as the epoxy resin, and magnet cracking occurred after performing the temperature cycle test. Comparative Examples 2 and 3 are blends of flexible resins instead of the bisphenol A type epoxy resin, and magnet cracking did not occur. However, when immersed in automatic transmission fluid, Comparative Example 2 exhibited a weight change rate of 19.9% and a dimensional change rate of 8.7%, and Comparative Example 3 exhibited a weight change rate of -45.1% and a dimensional change rate of −20.0%, and thus it is clear that both Comparative Examples 2 and 3 experienced a decrease in oil resistance. On the other hand, Comparative Example 4 is a blend of a flexible resin that differs from that of Example 1 for the epoxy resin, and the blending ratios are the same as the amount of Example 1, but because the weight change rate was −3.2%, it is clear that the cured product begins to dissolve in automatic transmission fluid, and oil resistance decreases.

As seen from the results of the above example 1 and comparative examples 1 to 4, a cured product of an adhesive obtained from a resin composition according to the embodiments of the present invention contains a bisphenol A type epoxy resin, an epoxy resin containing a polyoxyalkylene structure, and a curing agent as essential components. Thereby, the modulus of elasticity is low, the cured product exhibits excellent flexibility, and even if it is immersed for a long period of time in an automatic transmission fluid, a decrease in weight does not occur, and the exhibited dimensional change is minimal Therefore, it is clear that when the adhesive is cured, or when the adhesive is used in an environment with temperature changes after it is cured, magnet cracking can be prevented, and the adhesive can exhibit excellent oil resistance.

Embodiments of the present invention are particularly useful in the field of electronic and specially electrical insulating materials, more specifically when used as a liquid epoxy resin composition having flexibility and as an adhesive using the same.

While the principles of the disclosure have been described above in connection with specific apparatuses, it is to be clearly understood that this description is made only by way of example and not as limitation on the scope of the invention.

1. A liquid epoxy resin composition comprising a bisphenol A type epoxy resin, an epoxy resin containing a polyoxyalkylene structure, and a curing agent as essential components.

2. An adhesive containing the liquid epoxy resin composition according to claim 1.
